(19) United States
(12) Patent Application Publication
(10) Pub. No.: US 2012/0249527 A1
(43) Pub. Date: Oct. 4, 2012

(54) DISPLAY CONTROL DEVICE, DISPLAY CONTROL METHOD, AND PROGRAM

(75) Inventor: Takuro NODA, Tokyo (JP)

(73) Assignee: Sony Corporation, Tokyo (JP)

(21) Appl. No.: 13/364,466

(22) Filed: Feb. 2, 2012

(30) Foreign Application Priority Data
Mar. 31, 2011 (JP) 2011-078822

(51) Int. Cl. G06T 15/00

(52) U.S. Cl. 345/419

(57) ABSTRACT

A display control device includes, a calculation unit which calculates difference information which denotes a deviation between a predetermined first direction and a second direction from which a user views a stereoscopic image, a transformation unit which transforms the stereoscopic image on the basis of the difference information; and a display control unit which displays the transformed stereoscopic image on a display unit.

### BACKGROUND

The present disclosure relates to a display control device, a display control method, and a program, and particularly, relates to, for example, a display control device, a display control method, and a program which can display an object in a stereoscopic image as if the object is present in real space regardless of the viewing direction.

A stereoscopic display technology which displays a stereoscopic image on a display exists (for example, refer to Japanese Unexamined Patent Application Publication No. 11-164328).

Here, the stereoscopic image is an image which is configured by a left eye two-dimensional image and a right eye two-dimensional image, in which parallax is provided between the left eye two-dimensional image and the right eye two-dimensional image so that the object in the stereoscopic image which is visible to a viewer is to be stereoscopically viewed.

In addition, when the stereoscopic image is presented to the viewer, for example, such that the left eye two-dimensional image is presented to be visible with only the left eye, and the right eye two-dimensional image is presented to be visible with only the right eye.

The viewer is able to view the object in the stereoscopic image as if it is present in real space according to the parallax which is provided in the left eye two-dimensional image and the right eye two-dimensional image.

### SUMMARY

Meanwhile, in the above described stereoscopic display technology, a case is assumed that the viewer views the display from the front, and shapes of the object to be displayed on the left eye two-dimensional image and the right eye two-dimensional image are determined.

Accordingly, for example, when the viewer views the display in an oblique direction, the object in the stereoscopic image is viewed to be distorted, and it is different from an object which is viewed in real space.

It is desirable to a display control device which is able to display an object in a stereoscopic image as if the object is present in real space regardless of the viewing direction.

According to an embodiment of the present disclosure, there is provided a display control device which includes, a calculation unit which calculates difference information which denotes a deviation between a predetermined first direction and a second direction from which a user views a stereoscopic image; a transformation unit which transforms the stereoscopic image on the basis of the difference information; and a display control unit which displays the transformed stereoscopic image on a display unit.

The transformation unit may transform the stereoscopic image using an affine transformation based on the difference information.

The calculation unit may calculate the difference information which denotes an angle which is formed between the first direction and the second direction, and the transformation unit may transform the stereoscopic image using the affine transformation which inclines a coordinate axis which denotes the depth of an object in the stereoscopic image, on the basis of the difference information.

The display control device may further include, an imaging unit which images the user; and a detection unit which detects a user position which denotes the position of the user in a captured image which is obtained by the imaging unit, wherein the calculating unit may calculate the difference information on the basis of the user position.

The calculation unit may calculate the difference information which denotes a deviation between the first direction representing a normal line of a display screen of the display unit and the second direction.

The stereoscopic image is configured by a left eye two-dimensional image which is viewed by the user's left eye, and a right eye two-dimensional image which is viewed by the user's right eye, wherein the transformation unit may transform the left eye two-dimensional image and the right eye two-dimensional image, respectively.

According to another embodiment of the present disclosure, there is provided a display control method of controlling a display of a display control device which displays a stereoscopic image, the method includes, calculating difference information which denotes a deviation between a predetermined first direction and a second direction from which a user views the stereoscopic image by a calculation unit; transforming the stereoscopic image on the basis of the difference information by a transformation unit; and displaying the transformed stereoscopic image on a display unit by a display control unit.

According to still another embodiment of the present disclosure, there is provided a program which causes a computer to function as a calculation unit which calculates difference information which denotes a deviation between a predetermined first direction and a second direction from which a user views a stereoscopic image, a transformation unit which transforms the stereoscopic image on the basis of the difference information, and a display control unit which displays the transformed stereoscopic image on a display unit.

According to still another embodiment of the present disclosure, a calculation unit calculates difference information which denotes a deviation between a predetermined first direction and a second direction from which a user views the stereoscopic image, the stereoscopic image is transformed on the basis of the calculated difference information, and the transformed stereoscopic image is displayed on a display unit.

According to the present disclosure, it is possible to display as if an object in a stereoscopic image is present in real space regardless of the viewing direction.

### BRIEF DESCRIPTION OF THE DRAWINGS

FIG. 1 is a diagram which shows a configuration example of a personal computer according to the embodiment.

FIG. 2 is a first diagram which schematically describes processing of the personal computer.

FIGS. 3A and 3B are second diagrams which schematically describe the processing of the personal computer.

FIGS. 4A and 4B are third diagrams which schematically describe the processing of the personal computer.

FIG. 5 is a block diagram which shows a configuration example of a main body.

FIG. 6 is a diagram which describes processing of a face detection unit and an angle calculation unit in detail.

FIG. 7 is a diagram which describes a detailed processing of a transformation unit.

FIG. 8 is a flowchart which describes shearing transformation processing of the personal computer.

FIG. 9 is another diagram which describes the detailed processing of the transformation unit.

FIG. 10 is a block diagram which shows a configuration example of the computer.

### DETAILED DESCRIPTION OF EMBODIMENTS

Hereinafter, embodiments according to the present disclosure (hereinafter, referred to as the embodiment) will be described. In addition, the description will be made in the following order.
1. Embodiment (an example of a case where an object in a stereoscopic image is displayed as if it is present in real space, regardless of the viewing direction)
2. Modified example

### 1. EMBODIMENT

### [Configuration Example of a Personal Computer 21]

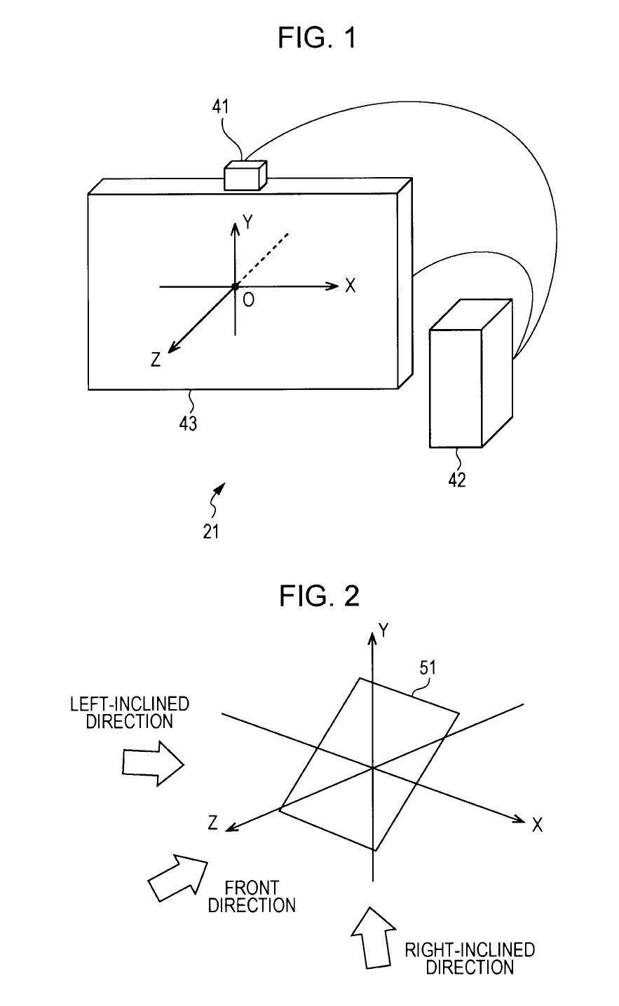

FIG. 1 is a configuration example of a personal computer 21 as the embodiment.

The personal computer 21 is configured by a camera 41, a main body 42, and a display 43.

The camera 41 images a user who views a stereoscopic image on the display 43 before the display 43, and a captured image which is obtained by the imaging is supplied to the main body 42.

The main body 42 detects a position of the user (for example, a position of the user's face, or the like) which is displayed on the captured image on the basis of the captured image from the camera 41. In addition, the main body 42 performs a shearing transformation of the stereoscopic image which is stored in a built-in storage unit according to the detected user's position, and supplies the shear transformed stereoscopic image to the display 43.

In addition, according to the embodiment, it is described that the shearing transformation is performed when transforming the stereoscopic image, however, the method of transforming the stereoscopic image is not limited thereto.

The display 43 displays the stereoscopic image from the main body 42. In addition, according to the embodiment, for convenience of explanation, the XYZ coordinate space shown in FIG. 1 will be defined. The XYZ coordinate space is defined by setting the center (the center of gravity) of a display screen of the display 43 to the origin O, and the X axis, Y axis, and Z axis respectively denoting the horizontal direction, the vertical direction, and the front direction (depth direction) of the display 43.

In addition, an optical axis of the camera 41 matches the Z axis in the X axis direction, and is deviated upward from the Z axis by a predetermined distance D_{y} in the Y axis direction.

### [Outline of Processing of Personal Computer 21]

Subsequently, an outline of processing of a personal computer 21 will be described with reference to FIGS. 2 to 4B.

The personal computer 21 is able to make an object 51 in the stereoscopic image be visible as if the object is present in real space, regardless of the visible direction, by causing the display 43 to display the stereoscopic image, as shown in FIG. 2.

That is, for example, when the user views the object 51 in the front direction, the main body 42 causes the display 43 to display the stereoscopic image in which the object is viewed as if the lower part of the object 51 is projected toward the user, and the upper part of the object 51 is viewed as if receding.

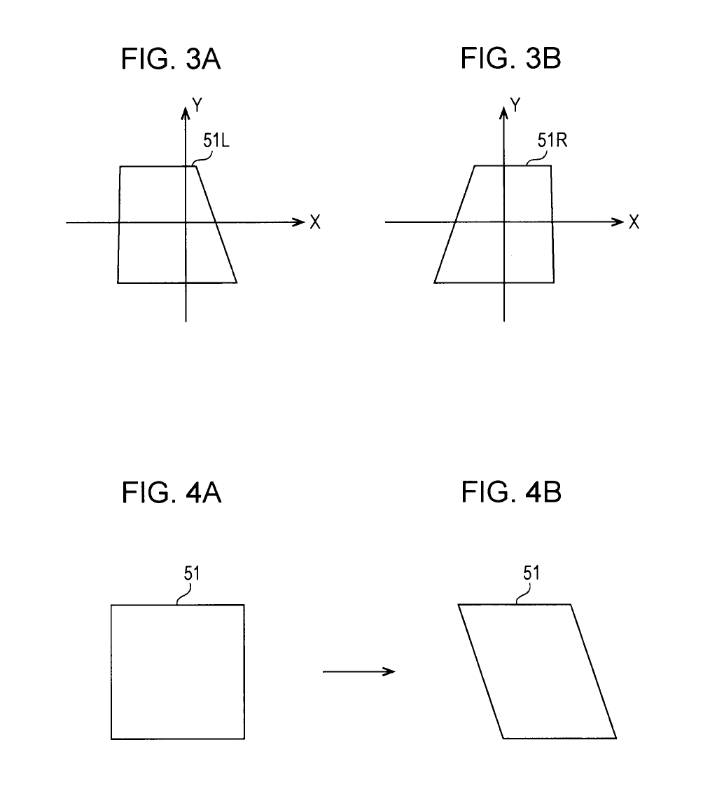

Specifically, for example, the main body 42 displays a stereoscopic image on the display 43, which is configured by a left eye two-dimensional image in which the object 51L with a shape as shown in FIG. 3A is displayed, and a right eye two-dimensional image in which the object 51R with a shape as shown in FIG. 3B is displayed.

In this case, when the object 51 is viewed from the front direction, the user is able to view such an object 51 which is shown in FIG. 4A, similarly to a case where the object 51 is present in real space. However, for example, when the object 51 is viewed from the right oblique direction (FIG. 2), as shown in FIG. 4B, a distorted object 51 is viewed, differently from a case where the object 51 is present in real space.

The present disclosure is to make the object 51 be viewed similarly to the case where the object 51 is present in real space, even when the object 51 is viewed, for example, from the right oblique direction, or the object 51 is viewed from the left oblique direction.

### [Configuration Example of Main Body 42]

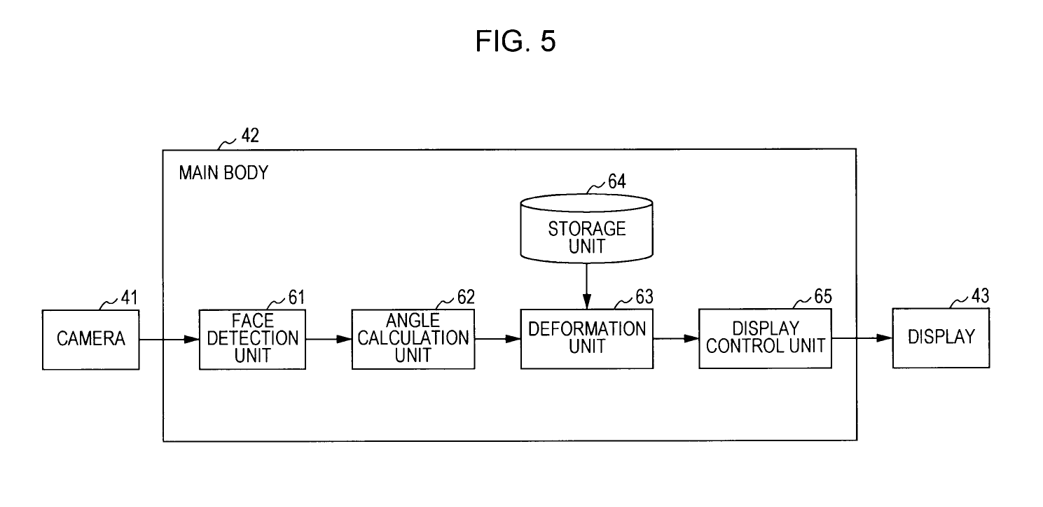

FIG. 5 shows a configuration example of the main body 42.

The main body 42 is configured by a face detection unit 61, an angle calculation unit 62, a transformation unit 63, a storage unit 64, and a display control unit 65.

A captured image is supplied to the face detection unit 61 from the camera 41. The face detection unit 61 detects a user's face which is displayed on the captured image, on the basis of the captured image from the camera 41. Specifically, for example, the face detection unit 61 detects an area of skin color from the entire area in the captured image, as a face area which denotes the user's face.

In addition, the face detection unit 61 detects a face position (Ax, Ay) which denotes a position of the user's face in the captured image, on the basis of the detected face area, and supplies the face position to the angle calculation unit 62. In addition, the face position (Ax, Ay) is set to, for example, the center of gravity of the face area. Further, the face position (Ax, Ay) sets, for example, the center on the captured image as the origin (0, 0), and is defined by the X axis and Y axis which intersect at the origin (0, 0).

In addition, in order to distinguish the X axis and Y axis which are defined on the captured image from the X axis and Y axis which are shown in FIG. 1, hereinafter, they are referred to as X′ axis and Y′ axis.

The angle calculation unit 62 calculates an angle θ which denotes a deviation between a face position (x, y) which denotes a position of the user's face on the XYZ coordinate space and the predetermined Z axis (FIG. 1), on the basis of the face position (Ax, Ay) from the face detection unit 61, and supplies the face position to the transformation unit 63.

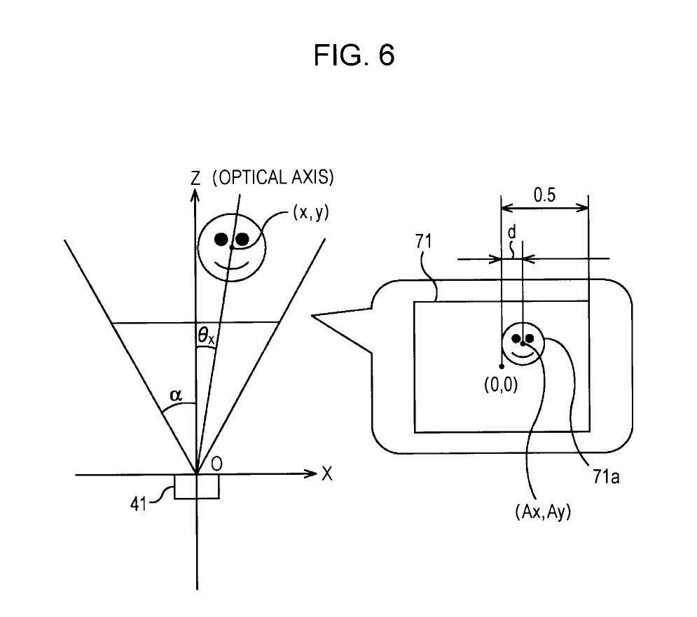

That is, for example, the angle calculation unit 62 calculates an angle θₓ which denotes a deviation between the face position (x, y) and the Z axis in the X axis direction, and an angle θ_{y} which denotes a deviation between the face position (x, y) and the Z axis in the Y axis direction, as the angle θ, and supplies the calculated angles to the transformation unit 63. In addition, processing of the face detection unit 61 and the angle calculation unit 62 will be described in detail with reference to FIG. 6.

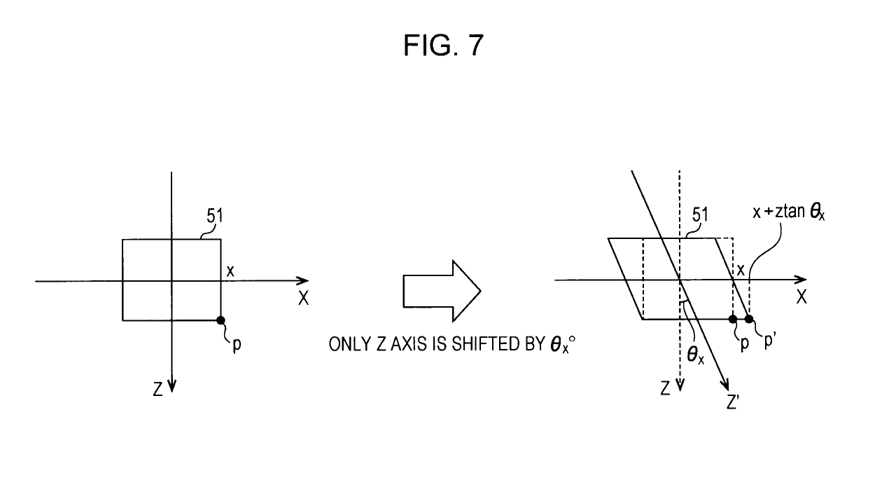

The transformation unit 63 reads out the stereoscopic image which is stored in the storage unit 64 from the storage unit 64. In addition, the transformation unit 63 performs shearing transformation of the stereoscopic image which is read out from the storage unit 64 on the basis of the angle θₓ and angle θ_{y}from the angle calculation unit 62, and supplies the stereoscopic image after the shearing transformation to the display control unit 65. In addition, processing of the transformation unit 63 will be described in detail with reference to FIG. 7.

The storage unit 64 stores the stereoscopic image to be displayed on the display 43.

The display control unit 65 supplies the stereoscopic image which is from the transformation unit 63 to the display 43, and causes the display 43 to display the stereoscopic image.

### [Detail of Face Detection Unit 61 and Angle Calculation Unit 62]

Subsequently, the detailed processing of the face detection unit 61 and the angle calculation unit 62 will be described with reference to FIG. 6.

The face detection unit 61 detects a face area 71a from a captured image 71 which is supplied from the camera 41, and is shown on the right side in FIG. 6. In addition, the face detection unit 61 detects, for example, the center of gravity of the face area 71a as the face position (Ax, Ay) in the captured image 71, and supplies to the angle calculation unit 62. Further, the face position (Ax, Ay) sets the center on the captured image 71, for example, to the origin (0, 0), and is defined by the X′ axis and Y′ axis which intersect at the origin (0, 0).

As shown on the right side in FIG. 6, the angle calculation unit 62 converts the Ax of the face position (Ax, Ay) from the face detection unit 61 to a value d by normalizing (dividing) the Ax by the width of the captured image 71. In addition, the position Ax on the X′ axis which denotes the right end portion of the captured image 71 is converted to 0.5 when being normalized by the width of the captured image 71.

In addition, as shown on the left side in FIG. 6, the angle calculation unit 62 calculates the angle θₓusing the following expression (1), on the basis of the value d obtained by normalization, and the half angle α of the camera 41 in the horizontal direction (X axis direction), and supplies the calculated angle to the transformation unit 63. In addition, in the angle calculation unit 62, the angle α is maintained in advance in the built-in memory (not shown).

θₓ=arc tan {d/(0.5/tan α)} (1)

In addition, the angle θₓdenotes a deviation between the face position (x, y) and the optical axis (imaging direction) of the camera 41 in the X axis direction.

Here, the optical axis of the camera 41 and the Z axis match each other in the X axis direction. Accordingly, it can be said, as well, that the angle θₓdenotes a deviation between the face position (x, y) and the Z axis in the X axis direction.

Meanwhile, the expression (1) can be obtained as follows. That is, if the value which changes according to the position z of the user's face on the Z axis is set to f(z), following expressions (2) and (3) are derived.

tan θₓ=d/f(z) (2)

tan α=0.5/f(z) (3)

From the expression (3), f(z)=0.5/tan α is derived, and when substituting this to the expression (2), following expression (4) is derived.

tan θₓ=d/(0.5/tan α) (4)

In addition, in the expression (4), when taking the inverse function of tan θₓ, the above described expression (1) is derived.

In addition, for example, the angle calculation unit 62 normalizes (divides) the Ay of the face position (Ax, Ay) from the face detection unit 61 by the height of the captured image 71, and adds an offset value which corresponds to the distance D_{y} to a value d″ which is obtained from a result thereof. In addition, the angle calculation unit 62 calculates the angle θ_{y} using the following expression (5) on the basis of a value d′ which is obtained due to the addition and the half angle β in the vertical direction (Y axis direction) of the camera 41, and supplies the calculated angle to the transformation unit 63.

θ_{y}=arc tan {d′/(0.5/tan β)} (5)

In addition, the value d′ is calculated by adding the offset value corresponding to the distance D_{y} to the value d″, when the optical axis of the camera 41 is deviated from the Z axis by the distance D_{y} in the Y axis direction. That is, when the angle calculation unit 62 calculates the angle θ_{y}, similarly to the case where the angle θₓ is calculated, the angle θ_{y} does not denote the deviation between the face position (x, y) and the Z axis in the Y axis direction.

Accordingly, the angle calculation unit 62 calculates the value d′ by adding the offset value to the value d″ in consideration of the deviation between the optical axis of the camera 41 and the Z axis in the Y axis direction, and calculates the angle θ_{y} using the expression (5). In addition, in the captured image 71, the distance from the position (0, y) (y<0) corresponding to the three-dimensional position (0, 0, z) on the XYZ coordinate space to the origin (0, 0) is the distance corresponding to the distance D_{y}, and the offset value is a value which is obtained by normalizing the distance from the position (0, y) to the origin (0, 0) in the captured image 71 by the height of the captured image 71.

### [Detail of Transformation Unit 63]

Subsequently, detailed processing of the transformation unit 63 will be described with reference to FIG. 7.

The transformation unit 63 reads out the stereoscopic image which is stored in the storage unit 64, and performs the shearing transformation of the read out stereoscopic image on the basis of the angles θₓ and θ_{y} from the angle calculation unit 62.

That is, for example, as shown in FIG. 7, the transformation unit 63 causes the Z axis to incline to the X axis by the angle θₓ which is from the angle calculation unit 62 in the Z axis in which the position z of the object 51 in the stereoscopic image is defined. Due to this, the x in the three-dimensional position p (x, y, z) of the object 51 becomes x+z tan θₓ.

In addition, for example, similarly, the transformation unit 63 causes the Z axis to incline to the Y axis by the angle θ_{y} which is from the angle calculation unit 62. Due to this, the y in the three-dimensional position p (x, y, z) of the object 51 becomes y+z tan θ_{y}.

In this manner, the transformation unit 63 performs the shearing transformation of the shape of the object 51, by performing the affine transformation of the three-dimensional position p (x, y, z) of the object 51 so as to be transformed to the three-dimensional position p′ (x+z tan θₓ, y+z tan θ_{y}, z) of the object 51.

In addition, in practice, the transformation unit 63 performs the shearing transformation of the object 51 by performing the affine transformation of the object 51L on the left eye two-dimensional image and the object 51R on the right eye two-dimensional image.

The transformation unit 63 supplies the stereoscopic image on which the object 51 which was performed with the shearing transformation is displayed to the display control unit 65. In addition, the display control unit 65 displays the stereoscopic image from the transformation unit 63 on the display 43.

### [Description of Operation of Personal Computer 21]

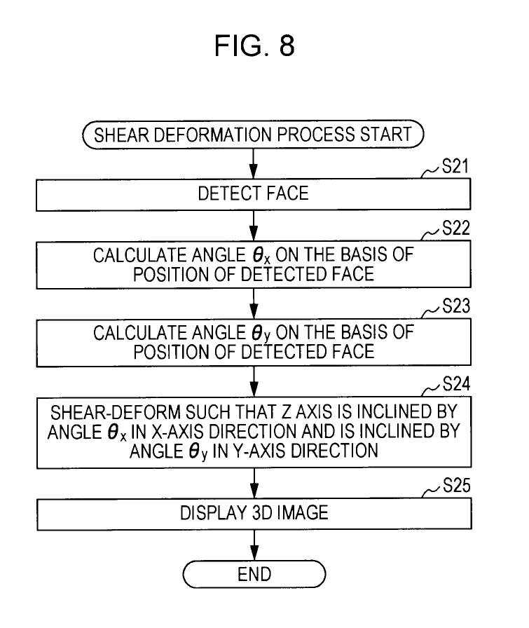

Subsequently, processing of the shearing transformation which is performed by a personal computer 21 will be described with reference to the flowchart in FIG. 8.

In addition, the processing of the shearing transformation is started when an operation unit (not shown) is operated so as to display the stereoscopic image on the display 43, for example. At this time, the camera 41 performs imaging, and supplies the captured image 71 which is obtained by the imaging to the face detection unit 61.

In step S21, the face detection unit 61 detects a user's face which is displayed in the captured image 71, on the basis of the captured image 71 from the camera 41. Specifically, for example, the face detection unit 61 detects an area of skin color from the entire area in the captured image 71, as a face area 71a which denotes the user's face.

In addition, the face detection unit 61 detects the face position (Ax, Ay) in the captured image 71 on the basis of the detected face area 71a, and supplies the face position to the angle calculation unit 62.

In step S22, the angle calculation unit 62 converts the Ax of the face position (Ax, Ay) from the face detection unit 61 to the value d by normalizing the Ax by the width of the captured image 71. In addition, the angle calculation unit 62 calculates the angle θₓ using the expression (1), on the basis of the value d which is obtained by normalizing, and the half angle α of the camera 41 in the horizontal direction (X axis direction), and supplies the angle to the transformation unit 63.

In step S23, the angle calculation unit 62 converts the Ay of the face position (Ax, Ay) from the face detection unit 61 to the value d″ by normalizing the Ay by the height of the captured image 71. In addition, the angle calculation unit 62 calculates the angle θ_{y} using the expression (5), on the basis of the value d′ which is obtained by adding the offset value to the value d″ obtained by normalizing, and the half angle β of the camera 41 in the vertical direction (Y axis direction), and supplies the angle to the transformation unit 63.

In step S24, the transformation unit 63 reads out the stereoscopic image which is stored in the storage unit 64 from the storage unit 64. In addition, the transformation unit 63 performs the shearing transformation of the object 51 on the read out stereoscopic image, on the basis of the angles θₓ and θ_{y} from the angle calculation unit 62, and supplies the stereoscopic image which was performed with the shearing transformation to the display control unit 65.

That is, for example, the transformation unit 63 causes the Z axis on the XYZ coordinate space in which the three-dimensional position of the object 51 in the stereoscopic image is defined to incline to the X axis by the angle θₓ which is from the angle calculation unit 62. In addition, the transformation unit 63 causes the Z axis to incline to the Y axis by the angle θ_{y} which is from the angle calculation unit 62. In this manner, the XYZ coordinate space is transformed, accordingly, the object 51 in the stereoscopic image is transformed due to the transformation of the XYZ coordinate space.

In step S25, the display control unit 65 supplies the stereoscopic image from the transformation unit 63, and causes the display 43 to displays the image. As described above, the shearing transformation is ended.

As described above, according to the shearing transformation processing, the angles θₓ and θ_{y} are calculated as the angle θ which is formed by the Z axis which is the normal line of the display screen of the display 43, and the direction from which the user views the display screen. In addition, the object 51 in the stereoscopic image is transformed, by causing the Z axis to incline to the horizontal direction (X axis direction) by the angle θₓ, and by performing the affine transformation in which the Z axis is inclined to the vertical direction (Y axis direction) by the angle θ_{y}.

For this reason, it is possible to display the object 51 in the stereoscopic image as if it is viewed in real space, regardless of the direction from which the user views the display screen.

In addition, for example, according to the shearing transformation processing, the object 51 on the XYZ coordinate space is performed with the shearing transformation, by changing the Z axis on the XYZ coordinate space. For this reason, it is possible to perform the processing by the transformation unit 63 further rapidly, compared to a case where the object on the XYZ coordinate space is performed with the shearing transformation, individually.

### 2. MODIFICATION EXAMPLE

As shown in FIG. 7, according to the embodiment, the coordinate of the object 51 is converted by causing the Z axis to be inclined, however, for example, in addition to that, it is possible to convert the coordinate of the object 51 without inclining the Z axis.

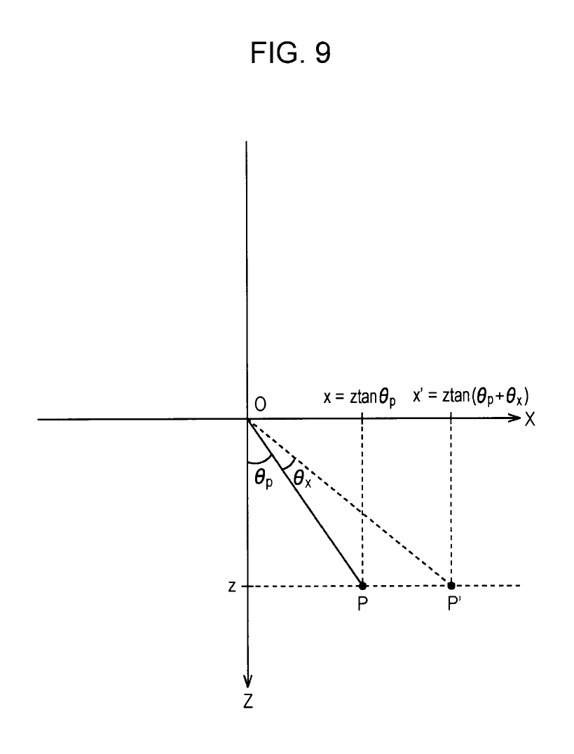

That is, for example, as shown in FIG. 9, the transformation unit 63 converts the position x (=z tan θₚ) of the three-dimensional position p (x, y, z) of the object 51 to the position x′ (=z tan(θₚ+θₓ)) on the basis of the angle θₓ from the angle calculation unit 62. In addition, as shown in FIG. 9, the angle θₚ is an angle formed by a line segment which connects the (x, z) of the three-dimensional position p (x, y, z) and the origin O, and the Z axis on the XZ plane which is defined by the X axis and the Z axis.

In addition, for example, similarly, the transformation unit 63 converts the position y (=z tan θ_{q}) of the three-dimensional position p (x, y, z) of the object 51 to the position y′ (=z tan(θ_{q}+θ_{y})) on the basis of the angle θ_{y} from the angle calculation unit 62. In addition, the angle θ_{q} is an angle formed by a line segment which connects the (y, z) of the three-dimensional position p (x, y, z) and the origin O, and the Z axis on the YZ plane which is defined by the Y axis and the Z axis.

In this manner, the transformation unit 63 is able to perform the shearing transformation of the object 51, by converting the three-dimensional position p (x, y, z) of the object 51 to the three-dimensional position p′ (x′, y′, z).

According to the embodiment, the direction from which the Z axis extends is caused to match the normal line direction of the display screen of the display 43, however, the direction from which the Z axis extends is not limited thereto, and may be different from this, according to the definition of the XYZ coordinate space.

According to the embodiment, the case where the three-dimensional position p (x, y, z) of the object 51 is already known is described, however, it is possible to apply the present technology when the three-dimensional position p (x, y, z) can be calculated, even when the three-dimensional position p (x, y, z) is not already known (for example, a case of a stereoscopic photograph, or the like).

In addition, the transformation unit 63 is assumed to perform the shearing transformation with respect to the stereoscopic image which is configured by, for example, a two-dimensional image for two viewpoints (left eye two-dimensional image and right eye two-dimensional image). However, the transformation unit 63 is able to perform the shearing transformation with respect to the stereoscopic image which is configured by, for example, a two-dimensional image for three or more viewpoints.

According to the embodiment, one camera 41 is used, however, it is possible to make the angle of view of the camera 41 be wide, or to use a plurality of cameras, in order to widen the range in which the user's face is detected.

In addition, for example, according to the embodiment, the angles θₓand θ_{y} are assumed to be calculated using the expressions (1) and (5), by calculating the values d and d′ from the face position (Ax, Ay) in the captured image 71 which is obtained from the camera 41.

However, in addition to that, the angles θₓ and θ_{y} may be calculated, for example, by detecting the face position (x, y, z) as the three-dimensional position on the XYZ coordinate space, and based on the detected face position (x, y, z), and the half angles α and β of the camera 41. That is, for example, tan θₓ=x/z . . . (2′), and tan α=g(z)/z . . . (3′) are derived from x and z of the detected face position (x, y, z). In addition, tan θₓ=x/(g(z)/tan α) . . . (4′) is derived from the expressions (2′) and (3′), and θₓ=arc tan (x/(g(z)/tan α)) . . . (1′) is derived when taking the inverse function of tan θₓ in the expression (4′). Accordingly, the angle θₓ is derived using the expression (1′). In addition, similarly, the angle θ_{y} is derived using the expression (5′) of θ_{y}=arc tan (y/(g(z)/tan β)).

In addition, in order to detect the face position as the three-dimensional position (x, y, z), for example, a stereo camera for detecting the face position (x, y, z) using the parallax of two cameras, an infrared light sensor, or the like for detecting the face position (x, y, z) by irradiating the user's face with infrared light, or the like is used.

In addition, according to the embodiment, the personal computer 21 is described, however, the present technology can be applied to any electronic device which can display the stereoscopic image. That is, for example, the present technology can be applied to a TV receiver which receives the stereoscopic image using airwaves, and displays the image, or a hard disk recorder which displays a recorded moving image as the stereoscopic image, or the like.

In addition, the present technology can be configured as follows.

(1) A display control device which includes, a calculation unit which calculates difference information which denotes a deviation between a predetermined first direction and a second direction from which a user views a stereoscopic image; a transformation unit which transforms the stereoscopic image on the basis of the difference information; and a display control unit which displays the transformed stereoscopic image on a display unit.

(2) The display control device described in (1), wherein the transformation unit transforms the stereoscopic image using an affine transformation based on the difference information.

(3) The display control device described in (2), wherein the calculation unit calculates the difference information which denotes an angle which is formed between the first direction and the second direction, and the transformation unit transforms the stereoscopic image using an affine transformation which inclines the coordinate axis which denotes the depth of an object in the stereoscopic image, on the basis of the difference information.

(4) The display control device described in (1) to (3), further includes, an imaging unit which images the user; and a detection unit which detects a user position which denotes the position of the user in a captured image which is obtained by the imaging unit, wherein the calculating unit calculates the difference information on the basis of the user position.

(5) The display control device described in (4), wherein the calculation unit calculates the difference information which denotes a deviation between the first direction representing a normal line of a display screen of the display unit and the second direction.

(6) The display control device described in (5), wherein the stereoscopic image is configured by a left eye two-dimensional image which is viewed in the user's left eye, and a right eye two-dimensional image which is viewed in the user's right eye, and the transformation unit transforms the left eye two-dimensional image and the right eye two-dimensional image, respectively.

Meanwhile, the above described series of processes can be executed using hardware or software. When the series of processing is executed using the software, a program for configuring the software is installed from a program recording medium to a computer which is built into the dedicated hardware, or, for example, a general purpose computer, or the like, which can execute a variety of functions by installing a variety of programs.

### [Configuration Example of Computer]

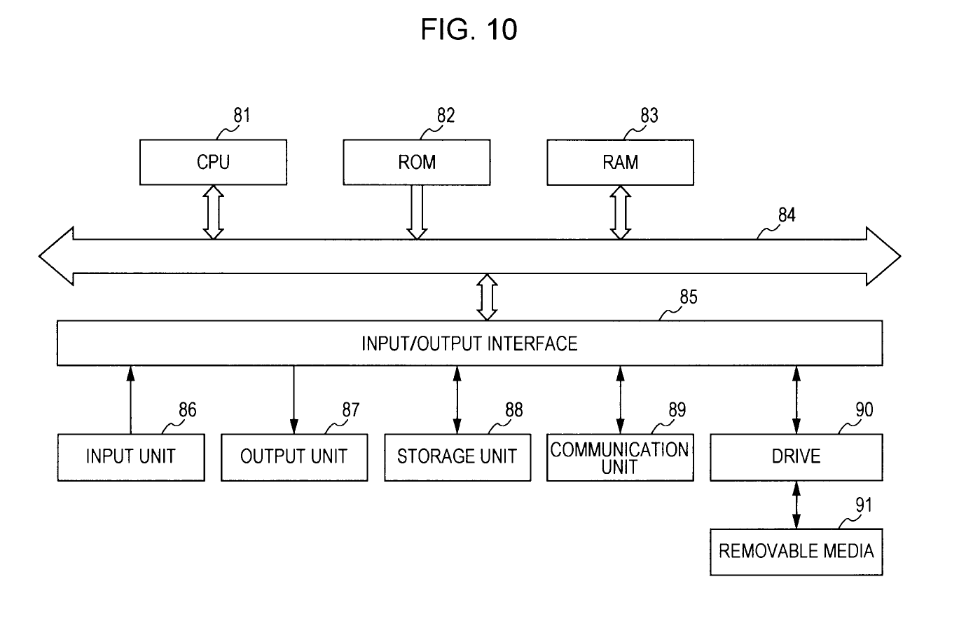

FIG. 10 shows a configuration example of hardware of a computer which executes the above described series of processing using the program.

A CPU (Central Processing Unit) 81 executes various processes according to a program which is stored in a ROM (Read Only Memory) 82, or a storage unit 88. A program, data, or the like which is executed by the CPU 81 is appropriately stored in a RAM (Random Access Memory) 83. These CPU 81, ROM 82, and RAM 83 are connected to each other using a bus 84.

An input/output interface 85 is also connected to the CPU 81 through the bus 84. An input unit 86 configured by a keyboard, a mouse, a microphone, or the like, and an output unit 87 which is configured by a display, a speaker, or the like are connected to the input/output interface 85. The CPU 81 executes various processing according to an instruction which is input from the input unit 86. In addition, the CPU 81 outputs the processing result to the output unit 87.

A storage unit 88 which is connected to the input/output interface 85 is configured by, for example, a hard disk, and stores programs which are executed by the CPU 81, and various data. A communication unit 89 communicates with an external device through a network such as a network, or a Local Area Network.

In addition, the program may be obtained through the communication unit 89, and be stored in the storage unit 88.

In addition, a drive 90 which is connected to the input/output interface 85 drives a magnetic disk, an optical disc, a magneto-optical disc, or a removable media 91 such as a semiconductor memory, when they are installed, and obtains the program, data, or the like which are recorded therein. The obtained program or data is transmitted to the storage unit 88 as necessary, and is stored.

As shown in FIG. 10, a recording medium which is installed to the computer, and records (stores) a program in a state of being executed by the computer is configured by the magnetic disk (including a flexible disk), the optical disc (including a CD-ROM (Compact Disc-Read Only Memory), DVD (Digital Versatile Disc)), the magneto-optical disc (including MD (Mini-Discs)), or the removable media 91 as a package media which is formed of the semiconductor memory or the like, or the ROM 82 in which a program is temporally or permanently stored, a hard disk which configures the storage unit 88, or the like. Recording of a program to the recording medium is performed using a wire or wireless communication medium such as a local area network, network, and digital satellite broadcasting, through the communication unit 89 as an interface such as a router, modem, or the like, as necessary.

In addition, according to the present disclosure, describing of the above described processing includes processing which is executed in parallel or individually, as well, even they are not necessarily processed in time series, in addition to the processing which is executed in time series according to the described order.

The present disclosure contains subject matter related to that disclosed in Japanese Priority Patent Application JP 2011-078822 filed in the Japan Patent Office on Mar. 31, 2011, the entire contents of which are hereby incorporated by reference.

In addition, the embodiments of the present disclosure are not limited to the above described embodiments, and may be variously changed without departing the scope of the present disclosure.

What is claimed is:

1. A display control device comprising:
a calculation unit which calculates difference information which denotes a deviation between a predetermined first direction and a second direction from which a user views a stereoscopic image;
a transformation unit which transforms the stereoscopic image on the basis of the difference information; and
a display control unit which displays the transformed stereoscopic image on a display unit.

2. The display control device according to claim 1,
wherein the transformation unit transforms the stereoscopic image using an affine transformation based on the difference information.

3. The display control device according to claim 2,
wherein the calculation unit calculates the difference information which denotes an angle which is formed between the first direction and the second direction, and
wherein the transformation unit transforms the stereoscopic image using the affine transformation which inclines a coordinate axis which denotes a depth of an object in the stereoscopic image, on the basis of the difference information.

4. The display control device according to claim 3, further comprising:
an imaging unit which images the user; and
a detection unit which detects a user position which denotes the position of the user in a captured image which is obtained by the imaging unit,
wherein the calculating unit calculates the difference information on the basis of the user position.

5. The display control device according to claim 4,
wherein the calculation unit calculates the difference information which denotes a deviation between the first direction representing a normal line of a display screen of the display unit and the second direction.

6. The display control device according to claim 5,
wherein the stereoscopic image is configured by a left eye two-dimensional image which is viewed in the user's left eye, and a right eye two-dimensional image which is viewed in the user's right eye, and
wherein the transformation unit transforms the left eye two-dimensional image and the right eye two-dimensional image, respectively.

7. A display control method of controlling a display of a display control device which displays a stereoscopic image, the method comprising:
calculating difference information which denotes a deviation between a predetermined first direction and a second direction from which a user views the stereoscopic image by a calculation unit;
transforming the stereoscopic image on the basis of the difference information by a transformation unit; and
displaying the transformed stereoscopic image on a display unit by a display control unit.

8. A program which causes a computer to function as,
a calculation unit which calculates difference information which denotes a deviation between a predetermined first direction and a second direction from which a user views a stereoscopic image;
a transformation unit which transforms the stereoscopic image on the basis of the difference information; and
a display control unit which displays the transformed stereoscopic image on a display unit.
